(19) United States
(12) Patent Application Publication
(10) Pub. No.: US 2009/0039006 A1
(43) Pub. Date: Feb. 12, 2009

(54) Portable Water-Treatment Bar

(76) Inventor: Chu-Yun Chung, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/836,257

(22) Filed: Aug. 9, 2007

(51) Int. Cl. B01D 35/30

(52) U.S. Cl. 210/226

(57) ABSTRACT

A portable water-treatment bar comprises an upper cap, a lower cap and multiple containing sections. The upper cap is circular and has an enlarged abutting rim at its top. The lower cap has a wedge portion with multiple passages. Each containing sections is hollow, has multiple holes defined on sidewalls and further has an insertion covered with a net. The multiple containing sections selectively accommodate different water-treatment materials and preferably combined with the each others and caps at two ends by supersonic binding to achieve the portable water-treatment bar that can be carried conveniently and inserted into a bottle container directly for water treatment.

### BACKGROUND OF THE INVENTION

1. Field of the Invention

The present invention relates to a water-treatment device, and more particularly to a portable water-treatment bar that can be carried conveniently and inserted into bottle container directly in use.

2. Description of Related Art

Generally, if drinking water is treated by mineral substance and alkaline ceramic in infrared magnetic mineral, the water molecules are activated and then suitable for drinking to improve body health. Because human body contains 70 weight percentages of water and the blood even contains 80 weight percentages of water, water molecules aggregate and become inert water composed of four hydrogen atoms and one oxygen atom when the body is weak. The inert water can not pass the cell membrane but the infrared makes the inert water molecules oscillate and invert into independent water molecule composed of two hydrogen atoms and one oxygen atom so that the oxygen content in the body is increased. Alkaline is drinking water can be easily absorbed by human body and efficiently combined with acidic toxicity with positive ions and metabolites to make those harmfill materials quickly released from the body. Therefore, when people drink the activated water, the oxygen content in the body can be increased and further the cells are activated and strengthened in energy to improve the disease-resistance and self-healing capability.

Recently, some manufacturers deposit the infrared magnetic mineral and the alkaline ceramic into cores of the drinking machine to achieve water treatment but it is inconvenient in carrying.

### SUMMARY OF THE INVENTION

A main objective of the present invention is to provide a portable water-treatment bar that has small size and is portable conveniently so that the bar can be directly inserted into bottle container to carry out water treatment to active, alkalize and disunite the water molecules. Therefore, convenience and utility of the portable water-treatment bar are improved.

Another main objective of the present invention is to provide a portable water-treatment bar that comprises an upper cap, a lower cap and multiple containing sections selectively accommodating materials and engaging in different numbers for different requirements to have excellent utility.

To achieve the foregoing objectives, the portable water-treatment bar comprising:

an upper cap having a top and an enlarged rim formed at the top;

a lower cap being tubular and having a wedge portion with a first net surface formed within the wedge portion; and

multiple containing sections secured between the upper cap and the lower cap, each being tubular and having a top end, a sidewall, an insertion formed at the top end with a second net surface formed within the insertion, and multiple water holes defined on the sidewall.

By having above described structure, the water-treatment bar can be mounted on a bottle conveniently and changed for different requirements by replacing the containing sections with different treating materials.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a portable water-treatment bar in accordance with the present invention;

FIG. 2 is a perspective view of the portable water-treatment bar in FIG. 1, wherein the portable water-treatment bar is assembled;

FIG. 3 is a cross-sectional view of the portable water-treatment bar in FIG. 2;

FIG. 4 is an operational perspective view of the portable water-treatment bar in FIG. 2, wherein the portable water-treatment bar is adapted to combine with a bottle;

FIG. 5 is an operational cross-sectional view of the portable water-treatment bar combined with the bottle; and

FIG. 6 is an operational cross-sectional view of the portable water-treatment bar to show its detachment from the bottle.

### DETAILED DESCRIPTION OF THE PREFERRED EMBODIMENT

A portable water-treatment bar in accordance with the present invention comprises an upper cap, a lower cap and multiple containing sections. The upper cap is circular and has an enlarged abutting rim at its top. The lower cap has a wedge portion with multiple passages. Each containing sections is hollow, has multiple holes defined on sidewalls and further has an insertion covered with a net. The multiple containing sections selectively accommodate different water-treatment materials and preferably combined with the each others and caps at two ends by supersonic binding to achieve the portable water-treatment bar that can be carried conveniently and inserted into a bottle container directly for water treatment.

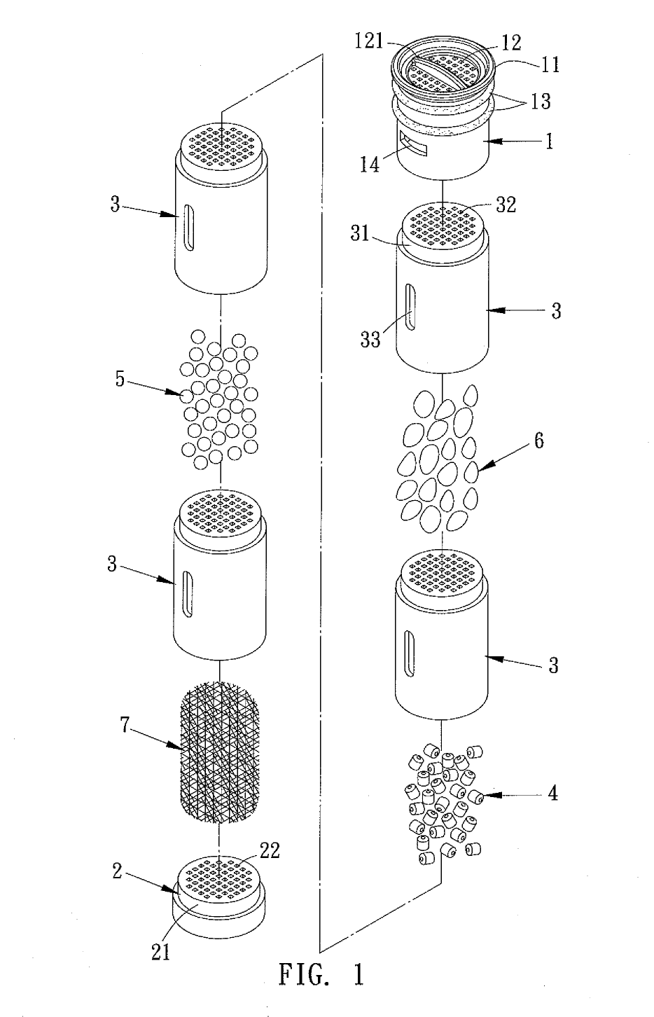

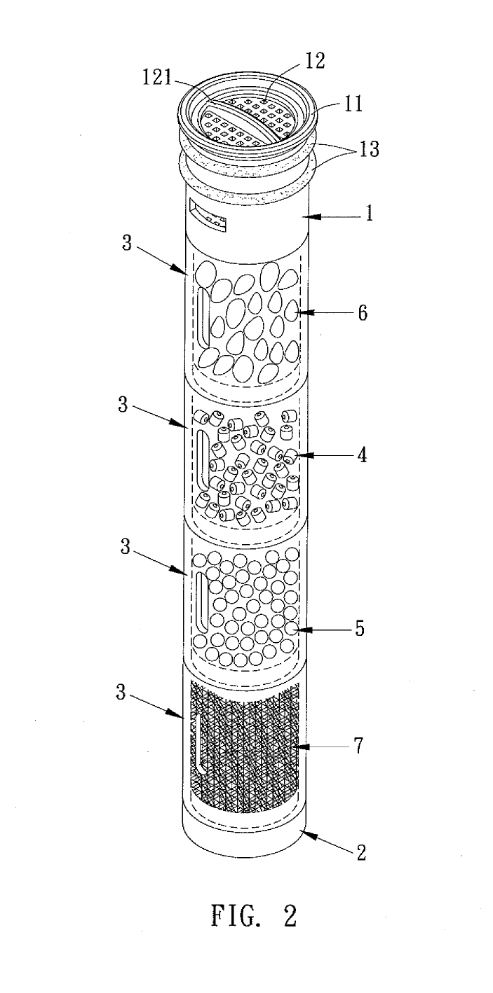

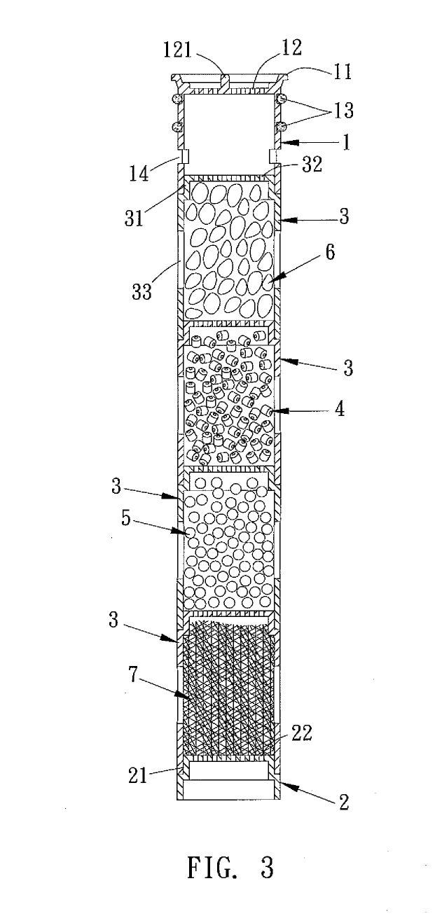

A preferred embodiment of the portable water-treatment bar is shown in FIGS. 1 to 3 and comprises an upper cap 1, a lower cap 2 and multiple containing tubes 3. The upper cap 1 is a tubular and has a top end, a sidewall, an outer periphery of the sidewall, a cone-shaped enlarged rim 11 formed at the top end and a net surface 12 covers the upper cap 1 at joint of the enlarged rim 11. A flange 121 is formed on the net surface 12 and two O-rings 13 are attached to the outer periphery of the upper cap 1. Two elongated holes 14 are defined on the sidewall. The lower cap 2 is also tubular and has a wedge portion 21 with a net surface 12 attached inside the wedge portion 21. Each containing tube 13 has an insertion 31 and also has a net surface 32 formed inside the insertion 31 and two opposite elongated water holes 33 defined in its sidewall longitudinally. The wedge portion 21 of the lower cap 2 is inserted into a lower end of the bottommost containing tube 3. After assembling, the joints between the containing tubes 3 and upper and lower caps 11, 12 are bound by supersonic binding to achieve the portable water-treatment bar.

When the portable water-treatment bar is assembled, the containing tubes 3 in desired number respectively accommodate infrared ceramic beads 4, negative ion ceramic beads 5, fresh-water pearls 6 and fiber of bamboo charcoal 7 etc. The insertion 31 of the topmost containing tube 3 is engaged with a lower end of the upper cap 1. Each insertion 31 of the other containing tubes 3 is attached to a lower end of an adjacent one mounted thereon. After assembling, the joints of the containing tubes 3 and the upper and lower caps 1, 2 are bound by supersonic binding to achieve the water-treatment bar that is portable conveniently. Additionally, the containing tubes 3 and upper and lower caps 1, 2 can be combined detachably by other engaging means such as threads.

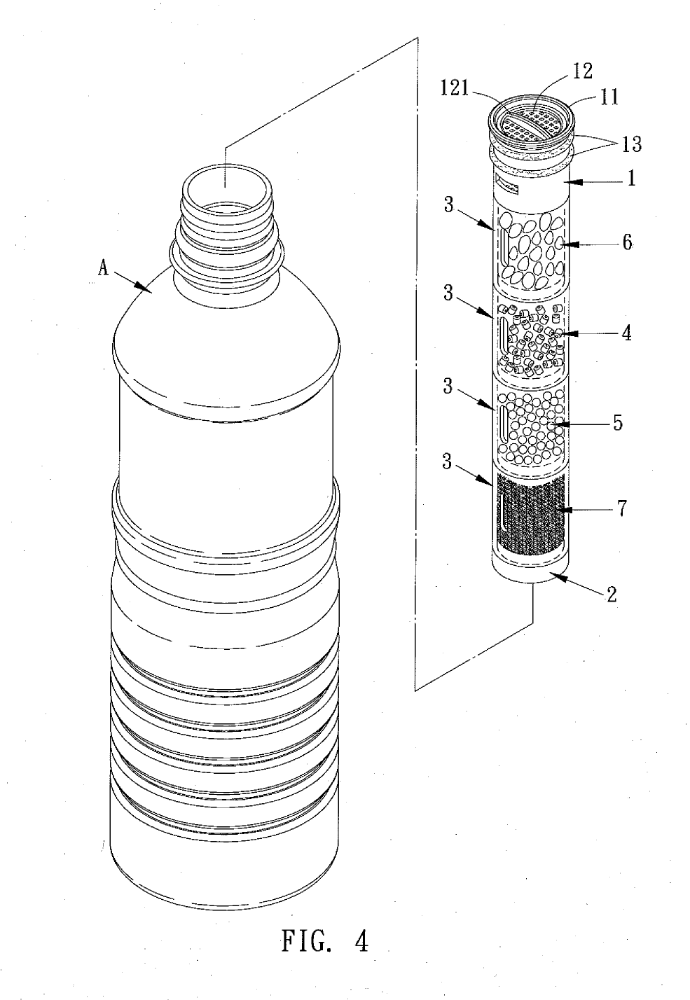

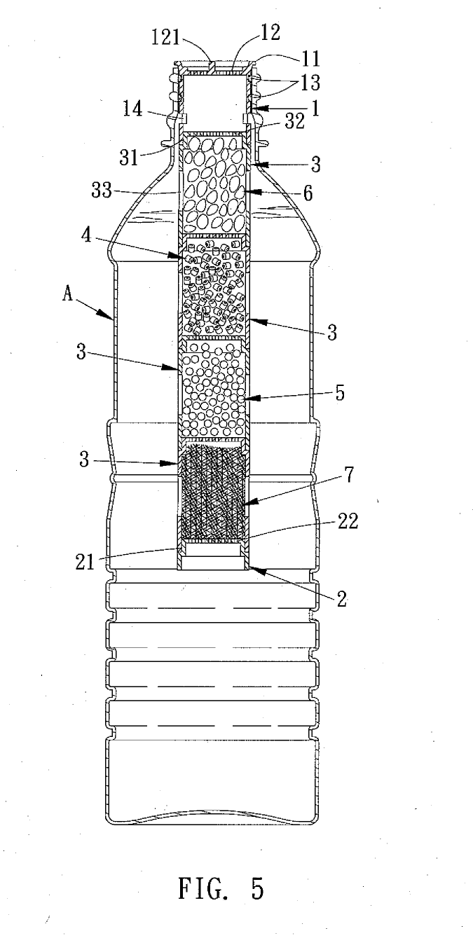

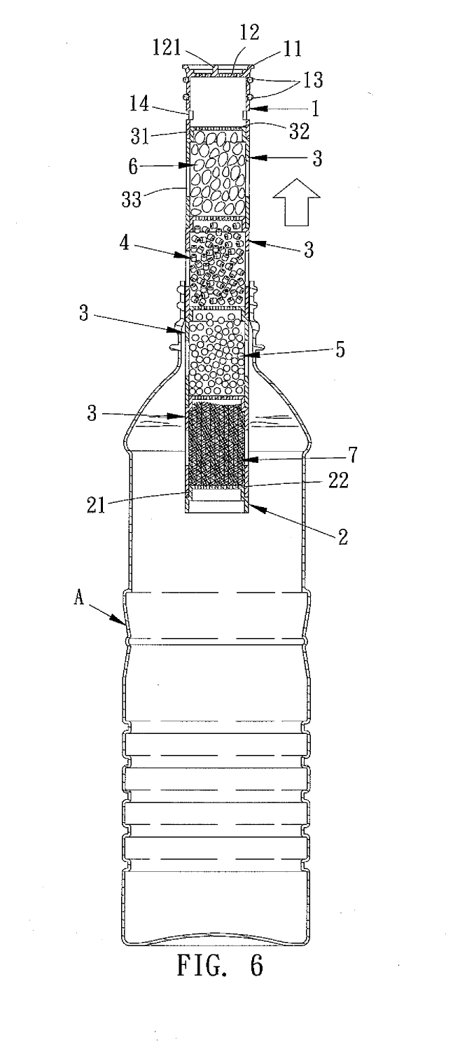

With reference FIGS. 4 to 6, when the portable water-treatment bar is in use, it is inserted into a bottle A or other similar container and mounted on the bottle by resting the cone-shaped enlarged rim 11 of the upper cap 1 on the mouth of the bottle A. After resting, the two O-rings 13 abut the inner periphery of the mouth of the bottle A and then a bottle cap can be mounted on the bottle for hermetical sealing.

By passing the net surface 22 of the lower cap 2 and the net surfaces and water holes 33 of the containing tube 3, the water inside the bottle contacts with the infrared ceramic beads 4, negative ion beads 5, fresh-water pearls 6 and fiber of bamboo charcoal 7 to active, alkalize and disunite the water molecules for treating. After water treatment, the water can be poured out of the bottle directly via the net surface 12 of the upper cap 1 or after the portable water-treatment bar is detached by pulling the flange 121 or the cone-shaped enlarged rim 11.

According to above description, the portable water-treatment bar has the following advantages:

1. The portable water-treatment bar has small size and is convenient in carrying. Moreover, the portable water-treatment bar can be directly applied to bottle A to activate, alkalize and disunite the water molecules conveniently so that the portable water-treatment bar is improved in its convenience and utility.

2. The upper and lower caps 1, 2 and the multiple containing tubes 3 can be modified in number and selectively receive different treating materials according to different requirements to obtain excellent utility efficiency.

3. When the containing tubes 3 are detachable, the treating materials are replaceable for recycle and the portable water-treatment bar can be reused.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. A portable water-treatment bar comprising:
an upper cap having a top and an enlarged rim formed at the top;
a lower cap being tubular and having a wedge portion with a first net surface formed within the wedge portion; and
multiple containing sections secured between the upper cap and the lower cap, each being tubular and having a top end, a sidewall, an insertion formed at the top end with a second net surface formed within the insertion, and multiple water holes defined on the sidewall.

2. The portable water-treatment bar as claimed in claim 1, wherein the enlarged rim is cone-shaped.

3. The portable water-treatment bar as claimed in claim 1, wherein the upper cap is tubular.

4. The portable water-treatment bar as claimed in claim 3, wherein the upper cap further has a third net surface formed at inner periphery of the top and a flange formed on the third net surface.

5. The portable water-treatment bar as claimed in claim 1, wherein the upper cap further has at least one O-ring mounted on outer periphery of the upper cap.

6. The portable water-treatment bar as claimed in claim 1, wherein the upper cap has a sidewall and two opposite elongated holes defined on the sidewall of the upper cap.

7. The portable water-treatment bar as claimed in claim 1, wherein the water holes of the multiple containing sections are elongated longitudinally.
